(19) United States
(12) Patent Application Publication
(10) Pub. No.: US 2025/0089940 A1
(43) Pub. Date: Mar. 20, 2025

(54) INDOOR GRILL AND AIR FRYER COMBINATION PRODUCT

(71) Applicant: IB APPLIANCES US HOLDINGS LLC, Downers Grove, IL (US)

(72) Inventors: Elizabeth Lisiecki, Downers Grove, IL (US); Zhenjun Fu, Hangzhou (CN); Helen He, Toronto (CA)

(73) Assignee: IB APPLIANCES US HOLDINGS LLC, Downers Grove, IL (US)

(21) Appl. No.: 18/570,275

(22) PCT Filed: Aug. 12, 2022
(86) PCT No.: PCT/CN2022/112015

§ 371 Date: Dec. 14, 2023

(51) Int. Cl. A47J 37/06

(52) U.S. Cl. CPC A47J 37/0641

(57) ABSTRACT

An apparatus includes a housing; a chamber within the housing in which food to be grilled or air fried is disposed; a fan system; a heating element; and a food placement element comprising a surface on which the food is placed in the chamber. At least one of the heating element or the fan system is disposed below the food placement element.

### TECHNICAL FIELD

The present description relates generally to cooking products, and more specifically to a cooking product that operates as both an indoor grill and an air fryer.

### BACKGROUND

Indoor grills are a type of cooking product or appliance that allow food to be grilled indoors. Indoor grills may be used indoors because they do not emit, or emit sufficiently small amounts of, smoke external to the product. However, one feature of outdoor grills that indoor grills do not have is the ability to create grill lines or marks on the food being grilled. This is also the case for cooking appliances that function as both an indoor grill and an air fryer. Such products, as a result, do not give users the full grilling effect that outdoor grills provide.

### BRIEF SUMMARY

The present description describes an apparatus configured to operate as both an indoor grill and an air fryer includes: a housing; a chamber within the housing in which food to be grilled or air fried is disposed: a fan system; a heating element; and a food placement element comprising a surface on which the food is placed in the chamber. The food placement element is disposed between the chamber and at least one of the fan system or the heating element.

In other embodiments, an apparatus configured to operate as both an indoor grill and an air fryer includes: a housing; a chamber within the housing in which food to be grilled or air fried is disposed; a fan system; a heating element; a food placement element comprising a surface on which the food is placed in the chamber; and a porous protrusion extending into the chamber. The porous protrusion is configured to deliver air directed by the fan system into the chamber.

In other embodiments, an apparatus configured to operate as both an indoor grill and an air fryer includes: a housing; a chamber within the housing in which food to be grilled or air fried is disposed; a fan system; a heating element; food placement element comprising a surface on which the food is placed in the chamber; a container in which the heating element and the food placement element are disposed; and a fluid collector disposed below the container and removably engageable with the housing.

In other embodiments, an apparatus configured to operate as both an indoor grill and an air fryer includes: a housing; a chamber within the housing in which food to be grilled or air fried is disposed; a fan system; a heating element; a food placement element comprising a surface on which the food is placed in the chamber; a filter chamber in which a smoke filter is disposed; and at least one channel in fluid communication with the filter chamber and the chamber.

In other embodiments, an apparatus configured to operate as both an indoor grill and an air fryer includes: a housing; a chamber within the housing in which food to be grilled or air fried is disposed; a fan system; a heating element; a food placement element comprising a surface on which the food is placed in the chamber; and a lid removably engageable with the housing. The lid comprising a transparent portion that provides visual access into the chamber.

In other embodiments, an apparatus configured to operate as both an indoor grill and an air fryer includes: a housing; a chamber within the housing in which food to be grilled or air fried is disposed; a lid movable between a closed position to cover the chamber and an open position to expose the chamber; a fan system; a heating element; and a food placement element comprising a surface on which the food is placed in the chamber. The fan system is configured to stay activated for a predetermined time period upon at least one of: the apparatus is deactivated to stop cooking or the lid is moved to the open position.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 shows a perspective view of an indoor grill/air fryer combination.

FIG. 2 shows a perspective view of the indoor grill/air fryer combination of FIG. 1 without a lid.

FIG. 3A shows a perspective view of a first food placement element for grilling.

FIG. 3B shows a perspective view of a second food placement element for air frying.

FIG. 4 shows a perspective side view of the indoor grill/air fryer combination of FIG. 1, showing a heating element and a fan system.

FIG. 5 shows a perspective view of a food placement element and a food placement support in isolation.

FIG. 6 shows a perspective view of a food placement support in isolation.

FIG. 7 shows a perspective top view of a food placement support disposed in a housing of the indoor grill/air fryer combination of FIG. 1.

FIG. 8 shows a perspective top view of the indoor grill/air fryer combination of FIG. 1, with the food placement support removed.

FIG. 9 shows a perspective top view of the indoor grill/air fryer combination of FIG. 1, with the food placement support removed and a heating element mounting plate hidden.

FIG. 10 shows a perspective top view of the indoor grill/air fryer combination of FIG. 1, with the food placement support removed, and the heating element and heating element mounting plate hidden.

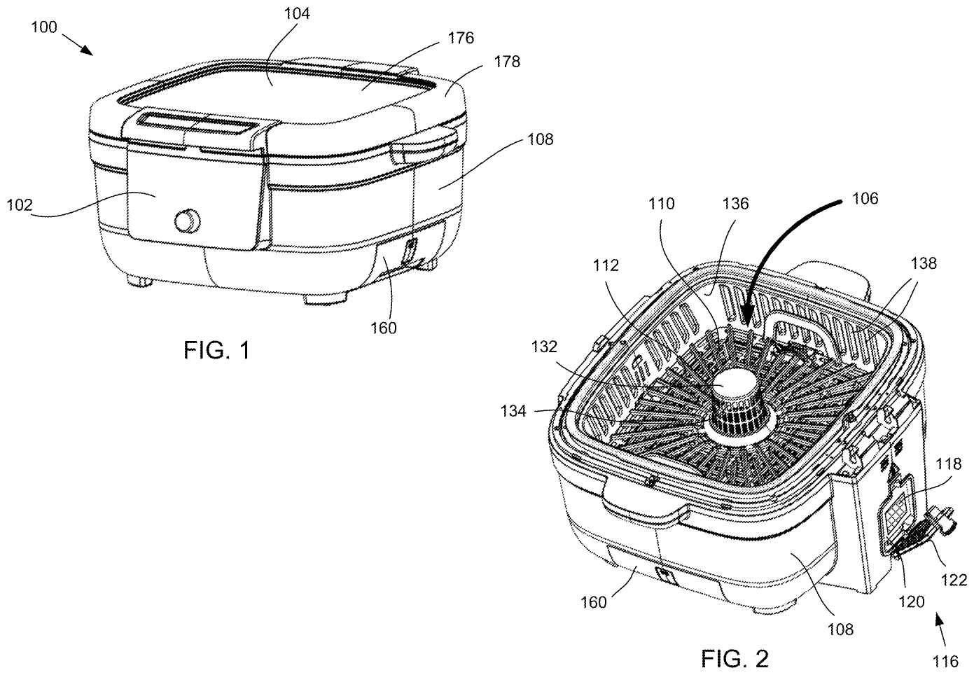

FIG. 1I shows a perspective side view of the indoor grill/air fryer combination of FIG. 1, with a housing hidden to show a lower fan disposed below a floor of a container.

FIG. 12 shows a heating element and an upper fan of the indoor grill/air fryer combination of FIG. 1 in isolation, with the heating element in an uncovered position.

FIG. 13 shows a perspective top view of the indoor grill/air fryer combination of FIG. 1, showing a container having an opening in fluid communication with a smoke filter chamber via a channel.

FIG. 14 shows a perspective side view of the indoor grill/air fryer combination of FIG. 1, with a housing hidden to show a fluid collector.

FIG. 15 shows a perspective view of the fluid collector shown in FIG. 14 in isolation without a cover.

FIG. 16 shows a perspective side view of the indoor grill/air fryer combination, with a lid decoupled from a housing.

FIG. 17 shows a perspective view of a lid of the indoor grill/air fryer combination, showing posts used to provide a removable coupling with a housing.

FIG. 18 shows a cross-sectional view of an example post of the posts in FIG. 17.

FIG. 19 shows a perspective view of a food placement support of the indoor grill/air fryer combination of FIG. 1, including an outer tab that prevents the food placement support from being positioned in the indoor grill/air fryer combination incorrectly.

### DETAILED DESCRIPTION

The present description describes various embodiments of a product, appliance, apparatus, cooking product, cooking appliance, cooking apparatus, and related methods that provide a combination of indoor grilling and air frying. For simplicity, such products, appliances, and apparatuses are referred to as an indoor grill/air fryer combination.

FIG. 1 shows a perspective view of an indoor grill/air fryer combination 100. The indoor grill/air fryer combination 100 is configured to operate in a plurality of cooking modes, including a grilling mode to grill food and in an air frying mode to air fry food. Other cooking modes for the indoor grill/air fryer combination 10) are possible in any of various embodiments, such as roasting and/or baking. Still other operation modes for the indoor grill/air fryer combination 100, such as dehydration and/or reheating, in various embodiments. In general, the indoor grill/air fryer combination 100 operates in the different cooking modes in an alternating manner or during different time periods. The indoor grill/air fryer combination 100 may include a control panel 102 configured receive a user input that allows a user to select a cooking mode. Upon receipt of a given cooking mode, the indoor grill/air fryer combination 100 may be configured to operate according to a set of operating characteristics that will, in turn, have a cooking effect on the food corresponding to the selected cooking mode. For example, if cooking mode “grill” is selected, the indoor grill/air fryer combination 100 may operate according to a set of operating characteristics associated with the “grill” cooking mode that will grill the food. As another example, if cooking mode “air fry” is selected, the indoor grill/air fryer combination 100 may operate according to a set of operating characteristics with the “air fry” cooking mode that will air fry the food.

As shown in FIG. 1, the indoor grill/air fryer combination 100 may include a lid 104 that is generally movable between two positions, including a closed position and an open position. In the open position, the lid 104 exposes an inner chamber 106 defined by a housing 108 of the indoor grill/air fryer combination 100 to its outer surroundings. When a user wants to cook food using the indoor grill/air fryer combination 100, the user may position the lid 104 in the open position, which enables the user to place the food in the chamber 106. Also, when the user wants to cook the food in the chamber 106, the user may position the lid 104 in the closed position. In the closed position, the lid 104 may cover, close off and/or seal the chamber 106 from the outer surroundings. FIG. 1 shows the lid 104 in the closed position.

FIG. 2 shows a perspective view of the indoor grill/air fryer combination 100 without the lid 106, showing the inner chamber 106. The indoor grill/air fryer combination 100 may include a food placement element 110 that includes a surface 112 on which food is placed in the chamber 106. In various embodiments, the food placement element 110 includes two different food placement elements, including a first food placement element intended to be used, positioned within the chamber 106, and/or on which food is to be placed when the indoor grill/air fryer combination 100 is operating in the grilling mode; and a second food placement element intended to be used, positioned within the chamber 106, and/or on which food is to be placed when the indoor grill/air fryer combination 100 is operating in the air fryer mode.

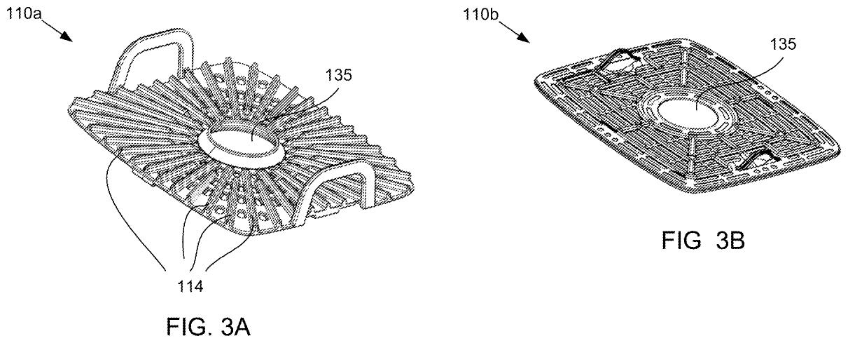

FIG. 3A and FIG. 3B show perspective views of example configurations of first and second food placement elements 110a, 110b, respectively. The first food placement element 110a used for grilling may be heavier in weight than the second food placement element 110b. The first and second food placement elements 110a, 110b may be removably disposed within the chamber 106, and/or may be interchangeable with each other. Also, referring to FIG. 3A in particular, the first food placement element 110a may include a set of raised ribs 114 that form the surface of the first food placement element 110a intended to make contact with food. When the indoor grill/air fryer combination 100 is operating in the grilling mode, the ribs 114 may create grill marks or lines on the food with which the ribs 114 are in contact.

Referring back to FIG. 2, the indoor grill/air fryer combination 100 may operate as an indoor grill in that, even when operating in an indoor environment (e.g., within a kitchen), it does not emit or output smoke due to grilling in a sufficient quantity so as to activate a smoke alarm or otherwise create an indoor air environment hazardous to breathing. In addition or alternatively, the indoor grill/air fryer combination 100 may minimize or suppress an odor or smell that smoke produces, such that a user does not detect smoke with his/her smell senses.

To minimize the impact of smoke in the surrounding (indoor) environment, the indoor grill/air fryer combination 100 may include a smoke filtration system 116 that filters out smoke from air within the indoor grill/air fryer 100. The smoke filtration system 116 may include a smoke filter (or just filter) 118 that, when subjected to smoke-filled air (or a mixture of air and smoke or air including smoke particles), captures the smoke particles of the smoke-filled air, and passes filtered air without (or with a reduced amount) of smoke particles to external to the indoor grill/air fryer combination 100. The smoke filtration system 116 may include a filter chamber 120 in which the filter 118 may be disposed. The filter 118 may be removably disposed within the filter chamber 120, such that a user can insert the filter 118 into the filter chamber 118 and/or remove the filter 118 from the filter chamber 120 any number of times or at any of different points in time. Additionally, the filter 118 may be configured to as a replaceable filter 118, such that a user can replace a current filter with a new or different filter, such as when the current filter has trapped a sufficient amount of smoke particles. For at least some embodiments, the indoor grill/air fryer 100, such as via the control panel 102, may indicate to a user to replace the filter 118. Also, as shown in FIG. 2, the indoor grill/air fryer combination 100 may include a filter door 122 configured to be opened and closed. A user may open the filter door 122 to remove a current filter 118 and replace it with a new one. In addition, a user may close the filter door 122 to keep the filter 118 securely within the filter chamber 120.

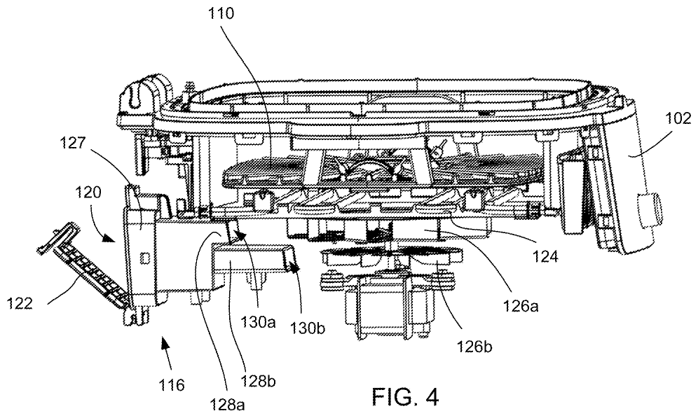

FIG. 4 shows a perspective side view of the indoor grill/air fryer combination 100 with most of the housing 108 hidden in order to show certain internal components in isolation. In particular, FIG. 4 shows the indoor grill/air fryer combination 100 as including a heating element 124 and a fan system 126. Each of the heating element 124 and the fan system 126 are positioned or disposed below the food placement element 110. As used herein, terms “above”, “below”, “top”, “bottom”, “under” and “over”, “upper”, and “lower” and other similar terms are used to describe components and relative positioning of the components of the indoor grill/air fryer combination 100 when the indoor grill/air fryer combination 100 is positioned in its intended position for operation on a base having a flat surface, such as a countertop or a tabletop, as non-limiting examples. In its intended position, the food placement element 110 is generally parallel with the flat surface of the base, with the surface 112 of the food placement element 110 facing away from the flat surface of the base. The term “top” is used to refer to the component or components of the indoor grill/air fryer combination 100 that are farthest from the flat surface of the base (e.g., the lid 104), and the term “bottom” is used to refer to the component or components that are closest to and/or that are in contact with, the flat surface of the base when the indoor grill/air fryer combination 100 is in its intended position. Correspondingly, the terms “above”, “over”, and “upper” are used to refer positioning or disposition of components closer to the “top” and farther from the “bottom” (or farther from the flat surface of the base), and the terms “below”, “under”, and “lower” are used to refer to positioning or disposition of components closer to the “bottom” and farther from the “top” (or closer to the flat surface of the base).

Referring further to FIG. 4, as mentioned, the heating element 124 and the fan system 126 may be disposed below the food placement element 110. Correspondingly, the food placement element 110 is disposed between the chamber 106 and the heating element 124 and the fan system 126. When activated, the heating element 124 generates heat according to a temperature setting determined by the control panel 102 in order to cook food on the food placement element 110, such as in accordance with a cooking mode. By the heating element 124 being positioned below the food placement element 110, when the first food placement element 110a used for grilling is positioned in the inner chamber 106, the heating element 124 may be configured to heat the food placement element 110a to a sufficiently high temperature, including when the indoor grill/air fryer combination is in the grilling mode, to cause the ribs 114 to create grill lines or marks on the food with which it is in contact.

Disposing the heating element 114 below the food placement element 110 may be in contrast to other configurations that position a heating element above the food placement element 110. For example, the food placement element may be a component of, or fixedly coupled to, the lid 104. However, for such configurations where the heating element is disposed above the food placement element, the heating element may not be able to heat the food placement element to enable or cause the food placement element to create grill marks or lines on the food. For example, in configurations where the heating element is above the food placement, the heating element is positioned a sufficient distance away from the food placement element so as to provide a desired amount or space or volume in which food can be disposed. However, that distance, and that the food is positioned between the heating element and the food placement element, may be prevent the heating element from being able to heat the food placement element to be able to create grill lines or marks on the food. In contrast, by placing the heating element 124 below the food placement element 110 such as shown in FIG. 4, the heating element 124 may be positioned closer to the food placement element 110, and may be positioned such that there is no food disposed between the heating element 124 and the food placement element 110, which in turn, may allow the heating element 124 to heat to food placement element 110 so as to allow or cause the food placement element 110 to create grill marks or lines on the food, creating a grilling functionality or experience that more desirably and closely resembles that of outdoor grills. The embodiments shown in the figures show both the heating element 124 and the fan system 126 disposed below the food placement element 110. However, in various embodiments, at least one of the heating element 124 or the fan system 126 is disposed below the food placement element 110. For example, in some embodiments, the heating element 124 may be below the food placement element 110 and the fan system 126 may be above the food placement element 110 (such as part of the lid 104, for example). In other embodiments, the heating element 124 may be above the food placement element 110 and the fan system 126 may be below the food placement element 110.

Also, as shown in FIG. 4, the fan system 126 is positioned below the heating element 124. The fan system 126 is configured to perform at least two functions, including: circulate heated air (air heated by the heating element 124) in the chamber 106 to facilitate cooking food on the food placement element 110, and facilitate smoke removal by directing air toward the filter 118 of the smoke filtration system 116.

In addition, for at least some embodiments such as in FIG. 4, the smoke filtration system 116 includes a filter housing 127 defining the filter chamber 120, and at least one hollow member 128 defining at least one channel 130. The at least one hollow member 128 extends from the filter housing 127 in a direction substantially parallel with the food placement element 110 to internally within the housing 108. The at least one channel 130 is in fluid communication with the filter chamber 120.

The fan system 126, in operation or when activated, may direct air in the chamber 106 and/or in an area below the chamber 106 to the at least one channel 130 for delivery to the filter 118. As the air may include smoke particles generated during cooking, the direction of the air into the at least one channel 130 caused by the fan system 126 facilitates the removal and/or filtration of smoke particles from within the chamber 106 and other areas internal to the indoor grill/air fryer 100, except the filter chamber 120, enabling the indoor grill/air fryer 100 to be used indoors with minimal or negligible impact from smoke.

Also, in some embodiments such as in FIG. 4, the fan system 126 includes two fans, including an upper fan 126a and a lower fan 126b. Correspondingly, the at least one channel 130 includes a dual channel system having two channels, including an upper channel 130a and a lower channel 130b. As shown in FIG. 4, the upper fan 126a and the upper 130a are substantially lateral with each other and/or are disposed at substantially the same height within the housing 108. Additionally, the upper and lower fans 126a, 126b each include a set of blades that rotate in respective planes, each parallel with the food placement element 110. The upper fan 126a circulates heated air (i.e., air heated by the heating element 124) in the chamber 106 and also directs air in the chamber 106 into the upper channel 130a toward the filter chamber 120, and the lower fan 126 directs air in an area below the chamber 106 into the lower channel 130b toward the filter chamber 120.

In some embodiments, the fan system 126, such a through control of the control panel 102, stays activated (i.e., the fan blades are rotating) for a predetermined time period after the indoor grill/air fryer combination 100 transitions from operating or being activated to not operating or being deactivated, such as when the indoor grill/air fryer combination 100 deactivates the heating element 124 to stop cooking. The indoor grill/air fryer combination 100 may transition from operating to not operating in response to a certain event, such as expiration of a timer or receiving a “stop cooking” or “cancel cooking” input on the control panel 102 from the user. In addition or alternatively, the fan system 126 stays activated for a predetermined time period after the lid 104 moves from the closed position to the open position. Upon expiration of the predetermined time period, the fan system 126 shuts off. By staying activated for the predetermined time period after the indoor grill/air fryer combination 100 transitions to being deactivated and/or when the lid 104 is opened, the fan system 126 continues to direct smoke toward the filter 118, and in turn desirably minimizes the impact of smoke in the surrounding indoor environment for a certain period of time after the indoor grill/air fryer combination 1I shuts off and/or the lid 104 is opened, exposing the chamber 106 to the outer surroundings of the indoor environment. In addition or alternatively, keeping the fan system 126 activated for the predetermined time period minimizes or controls build up of smoke in the indoor grill/air fryer combination 100 after cooking is complete and food particles continue to burn until the food placement element 110 or other surfaces sufficiently cool. Without keeping the fan system 126 activated for the predetermined time period, smoke build up may be released into the surrounding environment when the user opens the lid 104. For at least some embodiments, the predetermined time period is under ten minutes. For at least some of these embodiments, the predetermined time period is in a range between three minutes and seven minutes. For other of these embodiments, the predetermined time period is in a range between four minutes and six minutes. For still other of these embodiments, the predetermined time period is five minutes. Other time periods may be possible.

Referring back to FIG. 2, the indoor grill/air fryer 100 may further include a porous protrusion 132 extending into the chamber 106. The porous protrusion 132 is configured to deliver heated air (e.g., air heated by the heating element 124) into the chamber 106 to facilitate cooking food positioning on the food placement element 110. For at least some examples such as shown in FIG. 2, the porous protrusion 132 may be a hollow structure having an inner area. The fan system 126, including the upper fan 126a, may deliver, blow, or direct the heated air in an upward direction into the inner area. In the direction in which the food placement element 110 faces, the central axis of the porous protrusion 132 and the central axis of the upper fan 126a may be aligned with each other, and/or the porous protrusion 132 may be disposed over the upper fan 126a. A bottom or base or the porous protrusion 132 may be open above the upper fan 126, allowing the upper fan 126a to blow the heated air up into the inner area of the porous protrusion. In addition, as shown in FIG. 2, the porous protrusion 132 has a plurality of pores or holes 132 through which the heated air may flow in order to flow from within the inner area to the chamber 106.

In further detail, the porous protrusion 132 may have any of various three-dimensional shapes. For example, as shown in FIG. 2, the porous protrusion 132 is a frustum cone, although other three-dimensional shapes, such as a cone, pyramid, cylinder, or rectangular prism as non-limiting examples, may be possible. In addition or alternatively, in any of various embodiments such as shown in FIG. 2, the pores or holes 134 may be disposed on side walls of the porous protrusion 132, or otherwise face in a direction substantially perpendicular to the direction in which the food placement element 110 faces. In addition or alternatively, in any of various embodiments, such as shown in FIG. 2, the plurality of pores 134 may circumferentially extend 360 degrees around a center axis of the three-dimensional structure, and/or be substantially evenly distributed on the side walls of the porous protrusion 132, such that the porous protrusion 132 substantially evenly distributes or delivers the heated air from the inner area into the chamber 108. In addition or alternatively, in any of various embodiments such as shown in FIG. 2, the side walls may be configured as a grid or basket to define the pores 134.

Referring also to FIGS. 3A and 3B, the food placement element 110 (including the first and second food placement elements 110a, 110b) may have a hole 135. When the food placement element 110 is positioned in the chamber 106, the porous protrusion extends or projects through the hole 136.

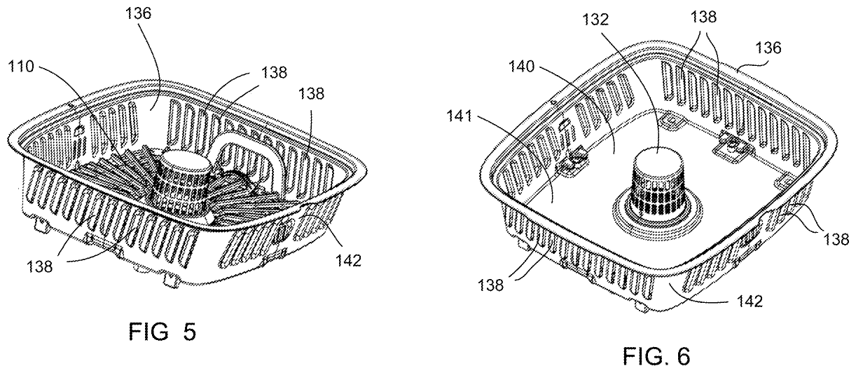

Referring back to FIG. 2, the indoor grill/air fryer combination 100 may also include a food placement support 136 on which the food placement element is disposed, positioned, and/or supported in the housing 108. Accompanying FIG. 2, FIG. 5 shows an isolated perspective view of the food placement element 110 positioned in the food placement support 136, and FIG. 6 shows an isolated perspective view of the food placement support 136 with the porous protrusion 132. As shown in FIG. 6, the food placement support 136 has a bottom surface 140 (also called an upper surface of a bottom 141 of the food placement support 136) on which the food placement element 110 may be disposed. Also, in at least some embodiments, the food placement element 110 is removably disposed on the food placement support 136, in that the food placement element 110 may be positioned onto and removed or separated from the food placement support 136 while the food placement support 136 stays within and/or coupled to the housing 108 of the indoor grill/air fryer combination 100. For example, the force of gravity may keep the food placement element 110 positioned in the food placement support 136, and a user can separate the food placement element 110 from the food placement support 136 by overcoming the force of gravity, such as by lifting the food placement element 110 out of the area in which the food placement element 110 is disposed in the food placement support 136.

The removable coupling between the food placement element 110 and the food placement support 136 provides various features. For example, the food placement element 110 and the food placement support 136 may be used for cooking and/or cleaned separately at different times. In addition or alternatively, the same food placement support 136 can be used with multiple or different food placement elements 110. For example, during a first period of time, the food placement support 136 may be used with (coupled to) the first food placement element 110a when grilling, and during a second period of time, the food placement support 136 may be used with (coupled to) the second food placement support 110b when air frying.

Also, as best shown in FIG. 6, for at least some embodiments, the food placement support 136 and the porous protrusion 132 are integral components. That is, the porous protrusion may be considered a part of the food placement support.

In addition, for at least some embodiments such as shown in FIGS. 2, 5 and 6, the food placement support 136 may include at least one vent 138 in a side wall 142. The vent 138 may function as a passageway through the side wall of the food placement support 138 through which air (including smoke-filled air) may flow from within an area of the chamber 106 defined by the food placement support 136. As described in further detail below, air exiting the chamber 106 through the vent 138 may flow to the upper channel 130a to the filter 118 (FIG. 4).

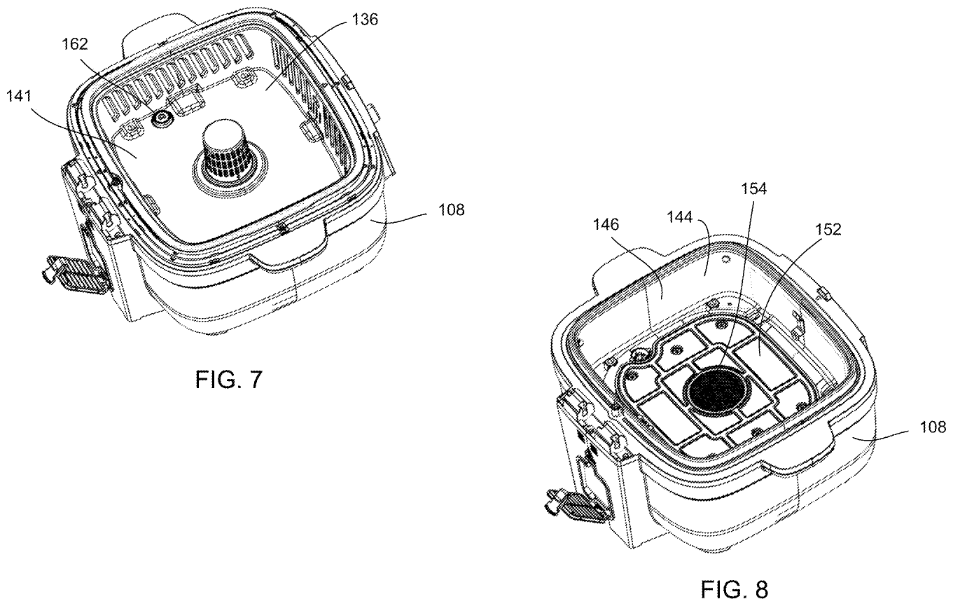

In addition, with reference to FIGS. 7 and 8, the food placement support 136 may be removably coupled to the housing 108 of the indoor grill/air fryer combination 100. In particular, the indoor grill/air fryer combination 100 may include a container 144, and the food placement support 138 may be removably coupled to and/or disposed within the container 144. For example, the food placement support 138 may be placed within the container 144, and upon placement, gravity may keep the food placement support 138 coupled to the container 144. A user may separate or decouple the food placement support 138 from the container 144 by overcoming gravity and lifting the food placement support 138 out of the container 144. FIG. 7 shows the food placement support 138 disposed in and coupled to the container 144. FIG. 6 shows the food placement support 138 as an isolated component when separated and/or removed from the container 144.

The food placement support 138 being removably coupled to the container 144, or in general the housing 108, may provide various features. For example, by being able to remove the food placement support 138 from the container 144, the food placement support 138 can separately or individually be cleaned. In addition or alternatively, the interior of the container 144 may be cleaned without being hindered by the food placement support 138.

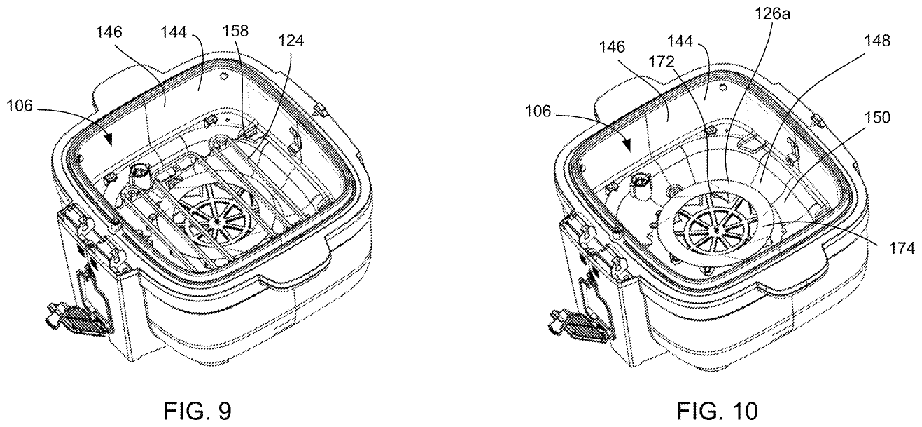

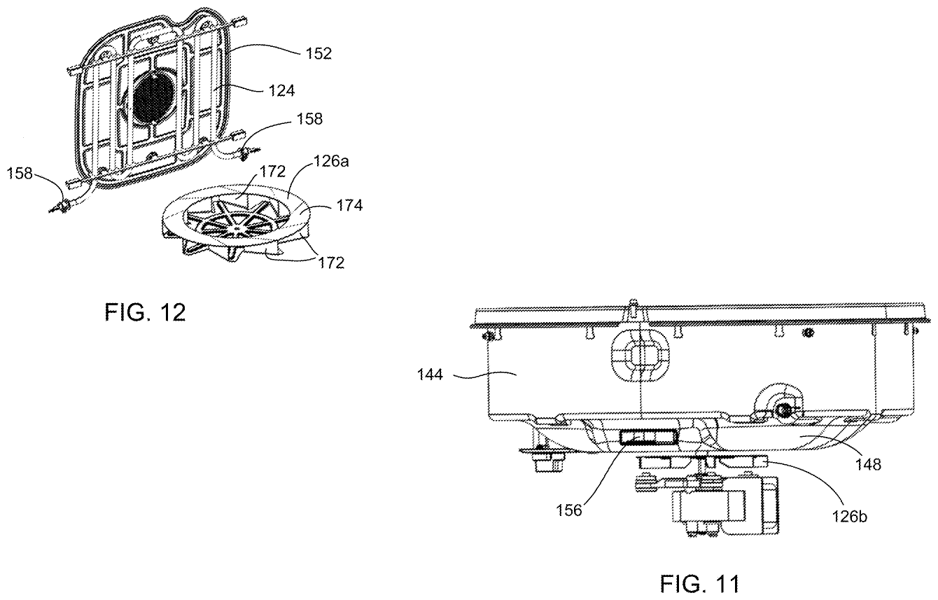

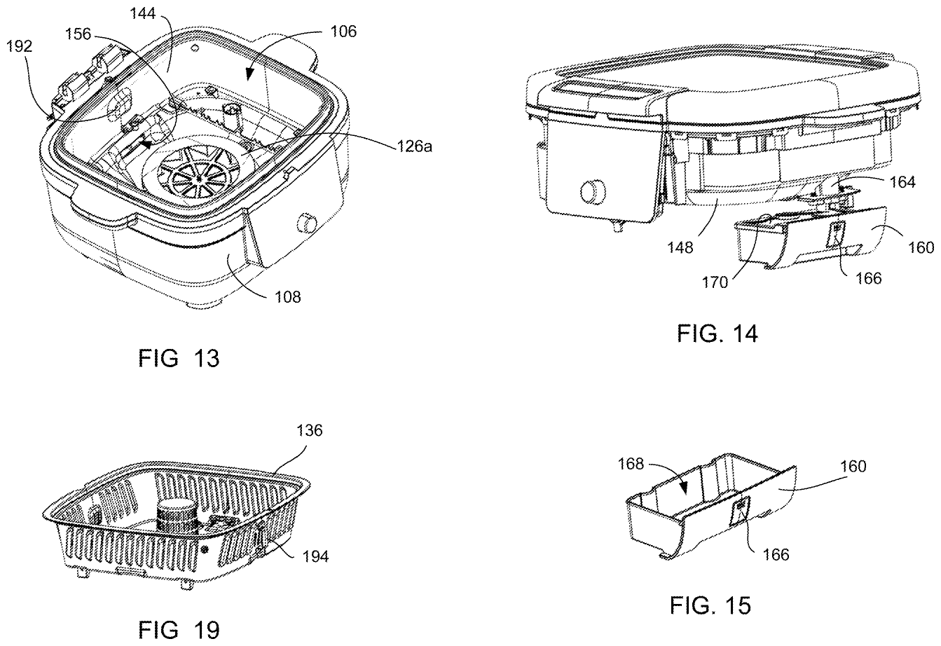

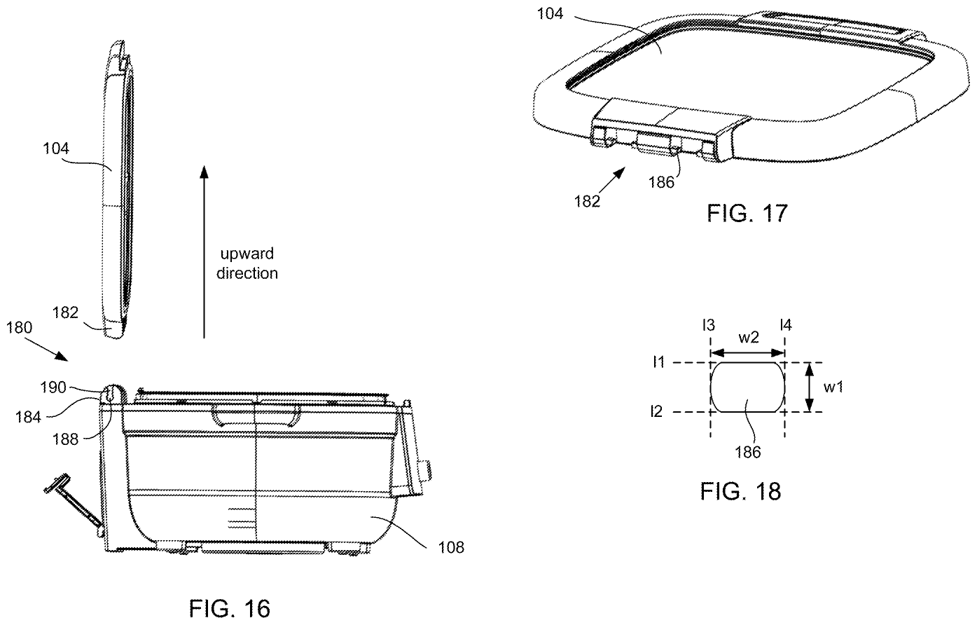

With further reference to FIGS. 9 and 10, the heating element 124 and the upper fan 126a may be disposed or positioned in the container 144. The container 144 may include an inner surface 146 that defines, at least in part, the chamber 106. Also, the chamber 144 may include a bottom component or floor 148 having an upper surface 150 that forms part of the inner surface 146 of the container 144. The heating element 124 and the upper fan 126a may be disposed in a lower chamber within the container 144 in between the floor 148 and the food placement element 110 and/or the food placement support 136.

FIG. 8 shows the inside of the container 144 when the food placement support 138 is removed. As shown in FIG. 8, removing the food placement support 138 exposes a mounting plate 152 to which the heating element 124 is coupled. FIG. 9 shows the indoor drill/air fryer combination 100 with the mounting plate 152 hidden to show the heating element 124. FIG. 10 shows the indoor grill/air fryer combination 100 with the heating element hidden to show the upper fan 126a. Accordingly, with reference to FIGS. 7-10, when the food placement support 138 is in the container 144, the bottom 141 (FIG. 6) of the food placement support 138 is directly above or over the mounting plate 152, the mounting plate 152 is directly above or over the heating element 124, the heating element 124 is directly above or over the upper fan 126a, and the upper fan 126a is directly above or over the floor 148 of the container 144. Also, with particular reference to FIG. 8, a central portion of the mounting plate 152 may include a mesh screen 154 through which the upper fan 126 may direct air into the inner area of the porous protrusion 132.

Referring to FIGS. 4, 11, and 13, the floor 148 of the container 144 may be disposed between and/or separate the upper fan 126a and the lower fan 126b. In this way, the lower fan 126 directs air below the floor 148 of the container 144 into the lower channel 130b. Also, the container may include an opening 156 that allows air to pass from within the container to outside the container 144. The opening 156 may be aligned with the upper channel 130a and be positioned at substantially the same height as the upper fan 126a and the upper channel 130a. Accordingly, the upper fan 126a may direct air from the chamber 106 through the opening 156 into the upper channel 130a to the filter 118. Also, as previously described with reference to 2, 5, and 6, the food placement support 136 may include vents 138 through which air (including smoke-filled air) in the chamber 106 may pass to outside the food placement support 136. Accordingly, an air flow path for air (including smoke-filled air) to travel from the chamber 106 to the air filter 118 may include from the chamber 106, through the vent 138 of the food placement support 136, through the opening 156 of the container 144, through the upper channel 130a, and into the filter chamber 120. In the filter chamber 120, the filter 118 may capture smoke particles and otherwise allow the air to pass through it, through the filter door 122, and to outside the indoor grill/air fryer combination 100. The upper fan 126a, in operation, may facilitate the air flow over this air flow path.

Referring to FIGS. 8, 9 and 12, for at least some embodiments, such as shown in those figures, the heating element 124 may be in the form of a serpentine coil, although any other shapes or configurations suitable for heating food according to the cooking modes of the indoor grill/air fryer combination 100 may be possible. Also, as shown in FIGS. 8, 9 and 12, the heating element 124 and/or the mounting plate 152 may be movable relative to the housing 108, the container 144, and/or the upper fan 126a. For example, the heating element 124 and the mounting plate 152 may be movable between a covered and an uncovered position. In the covered position, the heating element 124 and/or the mounting plate 152 covers or is disposed over the upper fan 126a, as shown in FIGS. 8 and 9. In the uncovered position, the heating element 124 and/or the mounting plate 152 does not cover and/or is not disposed over, so as to expose, the upper fan 126a. The movable heating element 124 and mounting plate 152, and in particular positioning the heating element 124 and mounting plate 152 in the uncovered position, may facilitate cleaning the upper fan 126a and/or the upper surface 150 of the floor 148.

Also, in particular embodiments such as shown in FIGS. 9 and 12, the heating element 124 may include ends 158 pivotably connected to the container 144 that allow the heating element 124 and the mounting plate 152 to pivot or rotate between the covered and uncovered positions. Other ways of configuring the heating element 124 and the mounting plate 152 to be movable relative to the container 144 and/or the upper fan 126a may be possible.

Referring to FIGS. 1 and 2, and also to FIGS. 14 and 15, the indoor grill/air fryer combination 100 may also include a fluid collector 160. A primary function of the fluid collector 160 may be to collect grease, although the fluid collector 160 is capable of collecting other or additional fluids, including those generated during cooking. Referring also to FIG. 7, the food placement support 136 may include a hole or opening 162 through which fluid may enter. The hole 162 may be in fluid communication with a channel that extends from the bottom 141 of the food placement support 136 to the floor 148 of the container 144. Referring to FIG. 14, a tubular or hollow member 164 may further extend the channel from the floor 148 to the fluid collector 160, where the fluid is finally contained.

Referring to FIGS. 13 and 19, the food placement support 136 may include an outer tab 194 (FIG. 19), such as a cutout tab, the protrudes or extends outwardly from a sidewall of the food placement support 136. Correspondingly, the inner surface of the container 144 may include a protrusion or bump 192 (FIG. 13). The protrusion 192 and the tab 194 may prevent the food placement support 136 from being inserted into the container 144 incorrectly. That is, when the food placement support 136 is inserted into the container 144 correctly, the hole 162 aligns with the channel to allow grease or other fluid in the food placement support 136 to enter into the flow 162 and flow into the grease collector 160. This will happen, however, only if the food placement support 136 is inserted into the container 144 one way—i.e., the correct way. If the food placement support 136 is inserted into the container 144 incorrectly, then the hole 162 will not be aligned with the rest of the channel. Accordingly, if the food placement support 136 is inserted into the container 144 incorrectly, the protrusion 192 and the tab 194 may prevent the food placement support 136 from being fully inserted into and/or disposed within the container 144, which in turn causes the user to remove the food placement support 136 from the container 144 and re-insert it the correct way so that the hole 162 is aligned with the rest of the grease collector channel.

Referring back to FIGS. 1, 2 14, and 15, the fluid collector 160 may be slidably and removably connected to the housing 108. For example, the fluid collector 160 may slidably engage and disengage with the housing 108 in a direction that is substantially parallel with the food placement element 110 (or substantially perpendicular to the direction that the food placement element 110 faces).

Also, for at least some embodiments such as best shown in FIGS. 14 and 15, the fluid collector 160 may include a window 166 that provides visual access into an area or volume 168 where the fluid is collected. The window 166 enables a user to determine how much fluid is in the fluid collector, which can enable the user to determine whether and/or when the fluid collector 160 should be emptied, while the fluid collector 160 is engaged with the housing 108, such as shown in FIGS. 1 and 2. Also, in some embodiments, the fluid collector may have a cover 170 over the fluid collection area 168. When the user wants to empty the fluid collector 160, the user can slidably disengage the fluid collector 160 from the housing 108, and remove the cover 170, to desirably create a larger area for the fluid to be removed from the fluid collector 160. FIG. 15 shows the fluid collector 160 in isolation without the cover 170.

The fluid collector 160 may differ from other configurations that utilize a tray positioned below the food placement element as a final repository for grease or other fluid to be collected and removed. Such trays may have to be cleaned by the user reaching into the chamber and/or by having to remove the food placement element in order to gain access to and/or remove the tray from the housing. In contrast, for the indoor grill/air fryer combination 100, the fluid collector 160 is positioned below the floor 148 of the container 144, and can slidably engage and disengage with the housing 108 without interference from any components within the container 144. For example, a user can remove the fluid collector 160 from the housing 108 and/or insert the fluid collector 160 into the housing 108 without having to first remove the food placement element 110 and/or the food placement support 136 from the container 144, which may facilitate the removal of grease or other fluid and/or the cleaning of the indoor grill/air fryer's final repository of grease.

Referring to FIGS. 10 and 12, for at least some embodiments, the upper fan 126a may include a set of blades 172, as previously described. Each blade 172 may be a planar structure parallel with a direction that the food placement element 110 faces. Also, the blades 172 are positioned circumferentially about a center point or axis of the upper fan 126a. Each blade 172 may have a length that extends over an upper edge from an inner end that is closest to the center point of the upper fan 126a to an outer end that is farthest from the center point. Also, each blade 172 may extend from its inner end to its outer end at an angle relative to a geometric ray extending from center point and intersecting the inner end of the blade 172. In addition or alternatively, the upper fan 126a may include a cover ring 174 oriented substantially parallel with the surface 112 of the food placement element 110. In various embodiments, the cover ring 174 may cover at least 50% of the lengths of the blades 172 over their upper edges. In particular of these embodiments, the cover ring 174 may cover 100% of the lengths. For example, the inner ends of the blades 172 may define an inner contour, and the outer ends of the blades 172 may define an outer contour. An outer circumference of the cover ring 172 may substantially match and/or be aligned with the outer contour of the blades 172, and an inner circumference of the cover ring 174 may substantially match the inner contour of the blades 172.

Referring to FIG. 1, for at least some embodiments, the lid 104 may include a clear or transparent portion 176 through which a person may see. When the lid 104 is in the closed position, the transparent portion 176 provides visual access into the chamber 106, allowing the user to view food being cooked in the chamber 106. In some embodiments, the transparent portion 176 makes up at least 50% of a top surface area of the lid 104. In particular of these embodiments, such as shown in FIG. 1, the transparent portion 176 comprises an entirety of the top surface area of the lid 104 except for an outer frame 178 that engages with top lips of the housing 108 and the food placement support 136 when the lid 104 is in the closed position. The transparent portion 176 may be particularly useful in combination the heating element 124 and the fan system 126 being positioned below the food placement element 110. In other configurations, when the heating element and/or fan system are above the food placement element, a transparent portion in the lid may not be useful since the heating element and the fan would block a user's view into the chamber 106 anyway.

Referring also to FIGS. 16 and 17, the lid 104 may be coupled to the housing 108 via a hinge assembly 180 or other similar connection that allows the lid 104 to pivot or move between open and closed positions. Also, for at least some configurations, the lid 104 is slidably and/or removably coupled to, and/or engageable with, the housing 108. That is, a lid-side portion 182 of the hinge assembly 180 is slidably and removably coupled to, and/or engageable with, the housing-side portion 184 of the hinge assembly 180. To do so, the lid-side portion 182 may include posts 186 that rotate or pivot within corresponding holes 188 on the housing-side portion 184. The housing-side portion 184 may also have grooves or tracks 190 having smaller widths than the corresponding holes 188. For the lid-side portion 182, the posts 186 may have a cross-sectional shape, such as a pill shape as shown in FIG. 18, that allows the posts 186 to slide through the tracks 190 when the lid 104 is in only one position, or a very small range of positions, between the open position and the closed position. For example, as shown in FIG. 18, the cross-sections of the posts 186 may have multiple different widths w, each geometrically defined by different corresponding parallel tangential lines. For example, a first width w1 is defined by parallel tangential lines l1 and l2, and a second width w2 is defined by parallel tangential lines 13 and 14. The cross-sectional shape, such as a pill shape, may provide only a sub-set of widths, among all possible widths, that is smaller than the width of the tracks 190. For example, the first width w1 may be smaller than the width of the tracks 190, and the second width w2 may be greater than the width of the tracks 190. When the lid 104 is in a particular position, or a small range of particular positions, between the open and closed positions, such that parallel tangential lines corresponding to a post width that is smaller than the track width are parallel with the tracks 190, then the posts 186 may slide through the tracks 190, decoupling the lid 104 from the housing 108. A decoupled lid 104 may be coupled to the housing 108 by sliding the posts 186 through the tracks 190 in a similar manner. For all other lid positions, where parallel tangential lines that are parallel with the tracks 190 correspond to widths that are greater than or equal to the track width, the lid 104, the posts 186 cannot slide through the tracks 190, and in turn, if coupled to the housing 108, cannot be slidably uncoupled, and if uncoupled from the housing 108, cannot be slidably coupled to the housing.

As shown in FIG. 16, for at least some configurations, the tracks 190 may extend substantially parallel with the direction that the food placement element 110 faces (i.e., the upward direction and/or a direction perpendicular to the surface of the base (e.g., countertop or tabletop) on which the indoor grill/air fryer combination 100 is disposed), and a coupled lid 104 may be decoupled from the housing 108, and a decoupled lid 104 may be coupled to the housing 108, when the lid 104 is in that same direction. The lid 104 configured to be slidably, removably coupled to the housing 108 may provide the feature that the lid 104 can be separately or independently washed or cleaned.

Also, while the embodiments described herein are particularly described as for an indoor grill/air fryer combination (e.g., an apparatus that can both grill and air fry food), one or more of the features described herein can also be implemented for a grill or an indoor grill, without necessarily having the capability to air fly. For example, the embodiments described herein with reference to FIGS. 1-19 may otherwise be an indoor grill that operates in a “grilling” mode but not in an “air frying” mode, and/or that does not have a food placement element 110b specifically for air frying.

The subject matter of the present description may also relate, among others, to the following aspects:

A first aspect includes an apparatus configured to operate as both an indoor grill and an air fryer, the apparatus comprising: a housing; a chamber within the housing in which food to be grilled or air fried is disposed; a fan system; a heating element; and a food placement element comprising a surface on which the food is placed in the chamber, wherein the food placement element is disposed between the chamber and at least one of the fan system or the heating element.

A second aspect includes the first aspect, and further includes: a porous protrusion extending into the chamber, the porous protrusion configured to deliver air directed by the fan system into the chamber.

A third aspect includes the second aspect, and further includes wherein the porous protrusion is in a shape of a frustum cone.

A fourth aspect includes any of the second or third aspects, and further includes wherein the food placement element comprises a hole through which the porous protrusion extends.

A fifth aspect includes any of the second through fourth aspects, and further includes a food placement support on which the food placement element is disposed.

A sixth aspect includes the fifth aspect, and further includes wherein the food placement support and the porous protrusion are integral components.

A seventh aspect includes any of the fifth or sixth aspects, and further includes wherein the food placement support comprises a side wall defining the chamber, wherein the sidewall comprises a vent in fluid communication with a filter chamber comprising a smoke filter disposed within the housing and external to the chamber.

An eighth aspect includes any of the fifth through seventh aspects, and further includes wherein the food placement support is configured as an insert that is removably coupled to an internal surface of the housing.

A ninth aspect includes any of the first through eighth aspects, and further includes wherein the heating element is movable relative to the housing.

A tenth aspect includes any of the first through ninth aspects, and further includes a lid coupled to the housing.

An eleventh aspect includes the tenth aspect, and further includes wherein the lid comprises a transparent portion that provides visual access into the chamber.

A twelfth aspect includes any of the tenth or eleventh aspects, and further includes wherein the lid is removably engageable with the housing.

A thirteenth aspect includes the twelfth aspect, and further includes wherein the lid is slidably engageable with the housing when oriented substantially parallel with an upward direction of the apparatus.

A fourteenth aspect includes any of the first through thirteenth aspects, and further includes: a fluid collector removably coupled to the housing.

A fifteenth aspect includes the fourteenth aspect, and further includes wherein the fluid collector is slidably engaged with the housing, the fluid collector engages with and disengages from the housing in a direction substantially parallel with the food placement element.

A sixteenth aspect includes any of the fourteenth or fifteenth aspects, and further includes wherein the fluid collector comprises a window that provides visual access into an internal volume of the fluid collector.

A seventeenth aspect includes any of the first through sixteenth aspects, and further includes wherein the food placement element comprises a first food placement element, the apparatus further comprising a second food placement element, wherein one of the first food placement element and the second food placement element is used to grill the food, and the other of the first food placement element and the second food placement element is used to air fry the food.

An eighteenth aspect includes the seventeenth aspect, and further includes wherein the one of the first food placement element and the second food placement element used to grill the food is heavier than the other of the first food placement element and the second food placement element used to air fry the food.

A nineteenth aspect includes any of the seventeenth or eighteenth aspects, and further includes wherein the one of first food placement element and the second food placement element used to grill the food comprises a set of ribs configured to create grill marks on the food with which the set of ribs is in contact.

A twentieth aspect includes any of the first through nineteenth aspects, and further includes a channel in fluid communication with a filter chamber for a smoke filter.

A twenty-first aspect includes the twentieth aspect, and further includes wherein the fan system is configured to direct air into the channel.

A twenty-second aspect includes any of the twentieth or twenty-first aspects, and further includes wherein the housing comprises a container in which the heating element and the food placement element are disposed, wherein the container comprises an opening in fluid communication with the channel.

A twenty-third aspect includes the twenty-second aspects, and further includes wherein the apparatus further comprises a food placement support on which the food placement element is disposed, the food placement support comprising a vent providing fluid communication between the chamber and the opening.

A twenty-fourth aspect any of the first through twenty-third aspects, and further includes wherein the fan system comprises a fan disposed below the floor, the fan configured to direct air into a channel in fluid communication with a filter chamber for a smoke filter.

A twenty-fifth aspect includes any of the first through nineteenth aspects, and further includes wherein the fan system comprises an upper fan and a lower fan, the upper fan disposed above a floor of a container in which the heating element and the food placement element are disposed, and the lower fan disposed below the floor, the apparatus further comprising: a dual channel system in fluid communication with a filter chamber for a smoke filter, the dual channel system comprising an upper channel and a lower channel, wherein the upper fan is configured to direct air above the floor to the filter chamber, and wherein the lower fan is configured to direct air below the floor to the filter chamber.

A twenty-sixth aspect includes the twenty-fifth aspect, and further includes wherein the upper fan is further configured to directed heated air into the chamber.

A twenty-seventh aspect includes any of the twenty-fifth or twenty-sixth aspects, and further includes wherein the upper fan comprises: a set of blades oriented substantially perpendicular to the surface of the food placement element; and a cover ring oriented substantially parallel with the surface of the food placement element blades, wherein the cover ring covers the set of blades.

A twenty-eighth aspect includes the twenty-seventh aspect, and further includes wherein at least one of: an outer circumference of the cover ring substantially matches an outer contour defined by the set of blades, or an inner circumference of the cover ring substantially matches an inner contour defined by the set of blades.

A twenty-ninth aspect includes any of the first through twenty-eighth aspects, and further includes wherein the fan system is configured to stay active for a predetermined time period upon at least one of: the apparatus is deactivated to stop cooking a lid is moved to an open position.

A thirtieth aspect includes the twenty-ninth aspect, and further includes wherein the predetermined time period is five minutes.

A thirty-first aspect includes an apparatus configured to operate as both an indoor grill and an air fryer, the apparatus comprising: a housing; a chamber within the housing in which food to be grilled or air fried is disposed; a fan system; a heating element; a food placement element comprising a surface on which the food is placed in the chamber; and a porous protrusion extending into the chamber, the porous protrusion configured to deliver air directed by the fan system into the chamber.

A thirty-second aspect includes an apparatus configured to operate as both an indoor grill and an air fryer, the apparatus comprising: a housing; a chamber within the housing in which food to be grilled or air fried is disposed; a fan system; a heating element; and a food placement element comprising a surface on which the food is placed in the chamber; a container in which the heating element and the food placement element are disposed; and a fluid collector disposed below the container and removably engageable with the housing.

A thirty-third aspect includes an apparatus configured to operate as both an indoor grill and an air fryer, the apparatus comprising: a housing; a chamber within the housing in which food to be grilled or air fried is disposed; a fan system; a heating element; a food placement element comprising a surface on which the food is placed in the chamber; a filter chamber in which a smoke filter is disposed; and at least one channel in fluid communication with the filter chamber and the chamber.

A thirty-fourth aspect includes an apparatus configured to operate as both an indoor grill and an air fryer, the apparatus comprising: a housing; a chamber within the housing in which food to be grilled or air fried is disposed; a fan system; a heating element; a food placement element comprising a surface on which the food is placed in the chamber; and a lid removably engageable with the housing, the lid comprising a transparent portion that provides visual access into the chamber.

A thirty-fifth aspect includes an apparatus configured to operate as both an indoor grill and an air fryer, the apparatus comprising: a housing; a chamber within the housing in which food to be grilled or air fried is disposed; a lid movable between a closed position to cover the chamber and an open position to expose the chamber; a fan system; a heating element; and a food placement element comprising a surface on which the food is placed in the chamber, wherein the fan system is configured to stay activated for a predetermined time period upon at least one of: the apparatus is deactivated to stop cooking or the lid is moved to the open position.

The foregoing description of various embodiments of the invention has been presented for purposes of illustration and description. Tt is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1-35. (canceled)

36. An apparatus configured to operate as both an indoor grill and an air fryer, the apparatus comprising:
a housing;
a chamber within the housing in which food to be grilled or air fried is disposed;
a fan system;
a heating element;
a food placement element comprising a surface on which the food is placed in the chamber; and,
a porous protrusion extending into the chamber, the porous protrusion configured to deliver air directed by the fan system into the chamber
wherein the food placement element is disposed between the chamber and at least one of the fan system or the heating element.

37. The apparatus of claim 36, wherein the porous protrusion is in a shape of a frustum cone.

38. The apparatus of claim 36, wherein the food placement element comprises a hole through which the porous protrusion extends.

39. The apparatus of claim 36, further comprising a food placement support on which the food placement element is disposed.

40. The apparatus of claim 39, wherein the food placement support and the porous protrusion are integral components.

41. The apparatus of claim 39, wherein the food placement support is configured as an insert that is removably coupled to an internal surface of the housing.

42. The apparatus of claim 36, wherein the heating element is movable relative to the housing.

43. The apparatus of claim 36, wherein the heating element is positioned below the food placement element, and the fan system is positioned below the heating element.

44. An apparatus configured to operate as both an indoor grill and an air fryer, the apparatus comprising:
a housing;
a chamber within the housing in which food to be grilled or air fried is disposed;
a fan system;
a heating element;
a food placement element comprising a surface on which the food is placed in the chamber; and
a lid removably engageable with the housing.

45. The apparatus of claim 44, wherein the lid comprises a transparent portion that provides visual access into the chamber.

46. The apparatus of claim 44, wherein the lid is slidably engageable with the housing when oriented substantially parallel with an upward direction of the apparatus.

47. The apparatus of claim 44, wherein the food placement element comprises a first food placement element, the apparatus further comprising a second food placement element, wherein one of the first food placement element and the second food placement element is used to grill the food, and the other of the first food placement element and the second food placement element is used to air fry the food.

48. The apparatus of claim 47, wherein the one of the first food placement element and the second food placement element used to grill the food is heavier than the other of the first food placement element and the second food placement element used to air fry the food.

49. The apparatus of claim 47, wherein the one of first food placement element and the second food placement element used to grill the food comprises a set of ribs configured to create grill marks on the food with which the set of ribs is in contact.

50. An apparatus configured to operate as both an indoor grill and an air fryer, the apparatus comprising:
a housing;
a chamber within the housing in which food to be grilled or air fried is disposed;
a lid movable between a closed position to cover the chamber and an open position to expose the chamber;
a fan system;
a heating element;
a food placement element comprising a surface on which the food is placed in the chamber;
a filter chamber in which a smoke filter is disposed; and
at least one channel in fluid communication with the filter chamber and the chamber;
wherein the fan system is configured to direct air into the channel.

51. The apparatus of claim 50, wherein the housing comprises a container in which the heating element and the food placement element are disposed, wherein the container comprises an opening in fluid communication with the channel.

52. The apparatus of claim 51, wherein the fan system comprises an upper fan and a lower fan, the upper fan disposed above a floor of the container in which the heating element and the food placement element are disposed, and the lower fan disposed below the floor, the apparatus further comprising:
a dual channel system in fluid communication with a filter chamber for a smoke filter, the dual channel system comprising an upper channel and a lower channel,
wherein the upper fan is configured to direct air above the floor to the filter chamber, and
wherein the lower fan is configured to direct air below the floor to the filter chamber.

53. The apparatus of claim 50, wherein the apparatus further comprises a food placement support on which the food placement element is disposed, the food placement support comprising a vent providing fluid communication between the chamber and the opening.

54. The apparatus of claim 53, wherein the upper fan is further configured to directed heated air into the chamber.

55. The apparatus of claim 50, wherein the fan system is configured to stay active for a predetermined time period upon at least one of: the apparatus is deactivated to stop cooking, or the lid is moved to an open position.
